(19) United States
(12) Patent Application Publication
(10) Pub. No.: US 2006/0007349 A1
(43) Pub. Date: Jan. 12, 2006

(54) Still image photographing method for reproducing color sense suitable for outdoor and indoor environments and apparatus for performing the same

(75) Inventor: Hung-Gi Chun, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/168,566

(22) Filed: Jun. 29, 2005

(30) Foreign Application Priority Data
Jul. 8, 2004 (KR) 2004-52850

(51) Int. Cl. H04N 5/238

(52) U.S. Cl. 348/363

(57) ABSTRACT

A still image photographing method for reproducing a color sense suitable for an indoor and outdoor environments and a photographing apparatus thereof are provided. The photographing method includes the steps of commanding a image photographing apparatus to photograph a still image; controlling an amount an aperture arranged on the apparatus is opened depending on incident light and determining whether the photographing is being captured indoors or outdoors depending upon the amount the aperture is opened; and controlling the apparatus so that photographing of the still image is based upon predetermined data set in advance that is suitable for the determined environment.

### CROSS-REFERENCE TO RELATED APPLICATIONS

This application claims the benefit of Korean Patent Application No. 2004-52850, filed Jul. 8, 2004, the entire disclosure of which is hereby incorporated by reference.

### BACKGROUND OF THE INVENTION

1. Field of the Invention

The present invention relates to a still image photographing method. More particularly, the present invention relates to a still image photographing method that can reproduce a color sense suitable for indoor and outdoor environments and an apparatus for performing the same.

2. Description of the Related Art

A typical camcorder may function as a video cassette recorder for recording objects on video tape or as a general camera for photographing an object.

Using the camcorder, a user may view recorded images using a view finder and a liquid crystal display monitor. Moreover, a user may view recorded images using an externally connected display device such as a television monitor.

In conventional camcorders, the same data associated with a color sense has been used for both indoor and outdoor photographing. Since the same data is used in both indoor and outdoor environments, green color sense is prevalent over the whole image that is photographed indoors. However, this causes a problem because reproduction of the color sense for the image photographed indoors is not optimal.

For example, when taking a photograph of an object using a camcorder under artificial light indoors, a green color sense is apt to be reproduced on the still image. Therefore, if a user uses the camcorder outdoors after color-sense is controlled to reduce a green color sense for indoor use, the green color sense is then under represented.

On the contrary, if a user sets color-sense related data so that a green color sense is well represented outdoors for an object such as a green leaf, a green color sense for an indoor photograph is over represented in the still image. Consequently, there is typically a color sense differential for indoor and outdoor use.

Accordingly, there is a need for an apparatus which provides color sense suitable for both indoor and outdoor use.

### SUMMARY OF THE INVENTION

An aspect of the present invention is to solve at least the above problems and/or disadvantages and to provide at least the advantages described below. Accordingly, an aspect of the present invention is to provide a still image photographing method capable of reproducing a color sense suitable for indoor and outdoor environments and an apparatus for performing the same that substantially obviates one or more problems due to limitations and disadvantages of the related art.

An object of the present invention is to provide a still image photographing method capable of reproducing a color sense suitable for indoor and outdoor environments and an apparatus for performing the same, capable of reproducing a color sense most appropriate for indoor and outdoor environments. The apparatus divides the location of the image into an indoor or outdoor environment and controls color-sense related data accordingly.

To achieve these objects and other advantages there is provided a still image photographing method capable of reproducing a color sense suitable for indoor and outdoor environments. The method includes the steps of commanding an image photographing apparatus to photograph a still image; controlling an amount an aperture arranged on the apparatus is opened depending on incident light; and determining whether the still image is being captured indoors or outdoors depending upon the amount the aperture is opened. The apparatus is controlled so that photographing of a still image is based upon predetermined data set in advance that is suitable for the determined environment.

The step of determining whether the photographing is being captured indoors or outdoors comprises the steps of detecting the opened amount of the aperture using a predetermined sensor and converting the detected opened amount into a predetermined voltage; comparing the predetermined voltage with a predetermined critical value so that if the predetermined voltage is smaller than the predetermined critical value as a result of the comparison, it is determined that the photographing is being captured one of indoors or outdoors. Alternatively, if the predetermined voltage is larger than the predetermined critical value as a result of the comparison, it is determined that the photographing is being captured the other of indoors or outdoors.

The predetermined data may be color-sense related data.

The predetermined sensor may be a Hall sensor and the predetermined voltage may be a Hall voltage which is outputted from the Hall sensor.

The predetermined critical value may be changeable by a user.

Another aspect of the present invention, there is provided an apparatus for performing a still image photographing method capable of reproducing a color sense suitable for indoor and outdoor environments. The apparatus includes an operation block for commanding photographing of a still image; an aperture configured to open and close a predetermined amount depending upon incident light; and a camera microcomputer for determining whether the still image is located in an indoor or outdoor environment depending upon the amount the aperture is opened. The camera microcomputer controls the photographing of the still image on the basis of predetermined data set in advance that is suitable for the determined environment.

Also, the apparatus of the present invention further includes a predetermined sensor for converting the detected opened amount of the aperture into a predetermined voltage for outputting. The predetermined voltage and the camera microcomputer compare the predetermined voltage with a predetermined critical value and determines whether that the photographing is being captured outdoors if the predetermined voltage is smaller than the predetermined critical value and determines that the photographing is being captured indoors if the predetermined voltage is larger than the predetermined critical value.

The predetermined sensor may be a Hall sensor.

The apparatus of the present invention further includes an EEPROM (electronically eraseable programmable read-only memory) for storing predetermined data set in advance suitable for indoor and outdoor environments, and a predetermined critical value.

The predetermined data may be color-sense related data.

The predetermined critical value may be changeable by a user.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a block diagram illustrating a construction of a photographing apparatus for reproducing a still image photographing method to reproduce color sense suitable for indoor and outdoor environments in accordance with an embodiment of the present invention; and

FIG. 2 is a flowchart detailing a still image photographing method for reproducing color sense suitable for indoor and outdoor environments in accordance with an embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness. I

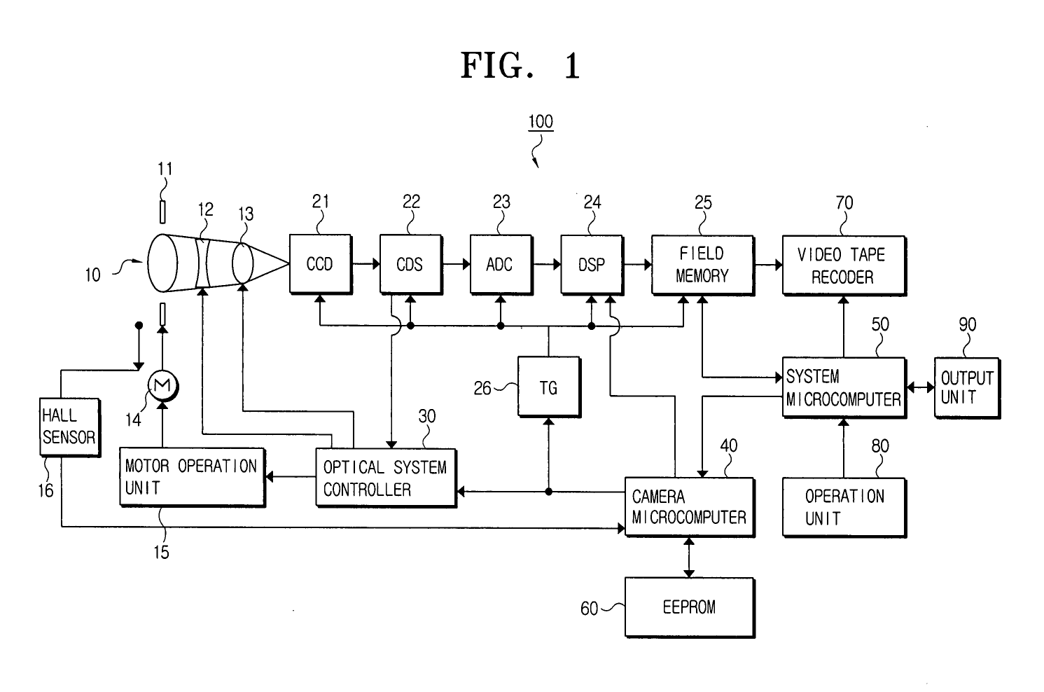

FIG. 1 is a block diagram illustrating a construction of a photographing apparatus, particularly a camcorder, for reproducing a still image photographing method for reproducing a color sense suitable for both indoor and outdoor environments in accordance with an embodiment of the present invention. Conventional camcorders generally include a digital video camera and a video tape recorder. The digital video camera processes image data photographed on a charged coupled device (CCD) 21 to record the processed data on a video tape recorder 70. Then, the processed data is transmitted to a personal computer (PC) (not shown) or is displayed on an output unit 90.

A lens system 10 includes an aperture 11, a zoom lens 12, and a focus lens 13. The aperture 11 limits a beam of light or a quantity of light. In other words, the aperture 11 controls an amount of light received by the camera.

The amount the aperture 11 is opened is controlled by a motor 14 which is operated by a motor operation unit 15. The amount the aperture 11 is opened is detected by a Hall sensor 16 and is recognized by a Hall voltage applied to a camera microcomputer 40 from the Hall sensor 16. An optical system controller 30 performs auto exposure and auto focus procedures to control the aperture 11 and focus of a lens.

Optical information inputted to the lens system 10 is provided to the CCD 21. The CCD 21 is an image pickup element. The CCD 21 converts optical information into an electrical signal. The electrical signal converted by the CCD 21 is provided to a correlated double sampling (CDS) unit 22.

The CDS 22 samples and amplifies an electrical signal received from the CCD 21. An analog signal double-sampled by the CDS 22 is provided to an analog-digital converter (ADC) 23.

The ADC 23 converts the analog signal double-sampled by the CDS 22 into a digital signal. The digital signal converted by the ADC 23 is provided to a digital signal processor (DSP) 24.

The DSP 24 separates the digital image signal provided from the ADC 23 into a brightness signal Y and a color signal C. The DSP 24 applies a predetermined process on the brightness signal Y and the color signal C and outputs the signals. The digital signals originated from a brightness signal Y and a color signal C are processed by the DSP 24, The digital signals are provided to the field memory 25 when photographing a still image and provided to the video tape recorder 70 via the field memory 25 when photographing a moving image. The video tape recorder 70 records an output of the DSP 24 on a magnetic tape.

The CCD 21, the CDS 22, the ADC 23, the DSP 24, and the field memory 25 are connected with a timing generator (TG) 26, respectively, and perform a predetermined process in response to a clock pulse and a synchronization signal from the timing generator 26.

The camera microcomputer 40 sets parameters of the DSP 24 and the timing generator 26 with reference to data regarding color-sense related coefficient and control values set in advance. The parameters are suitable for indoor and outdoor environments stored in the EEPROM 60. The camera microcomputer 40 performs focus and aperture controls using data of image signal detected in an inside of the DSP 24.

Data regarding color-sense related coefficient and control value set suitable for indoor and outdoor environments are stored in the EEPROM 60. Moreover, a Hall voltage critical value, which is a reference in determining the location of a photographing place of a camcorder, is also stored in the EEPROM 60.

The system microcomputer 50 controls operation of the camcorder 100. The system microcomputer 50 controls a variety of functions such as recording, playing, and zooming in accordance with an operation of a user. An operation unit 80 instructs operations such as a photographing of a moving image or a still image. Moreover, the operation unit 80 performs an operation for changing a position of the zoom lens 12.

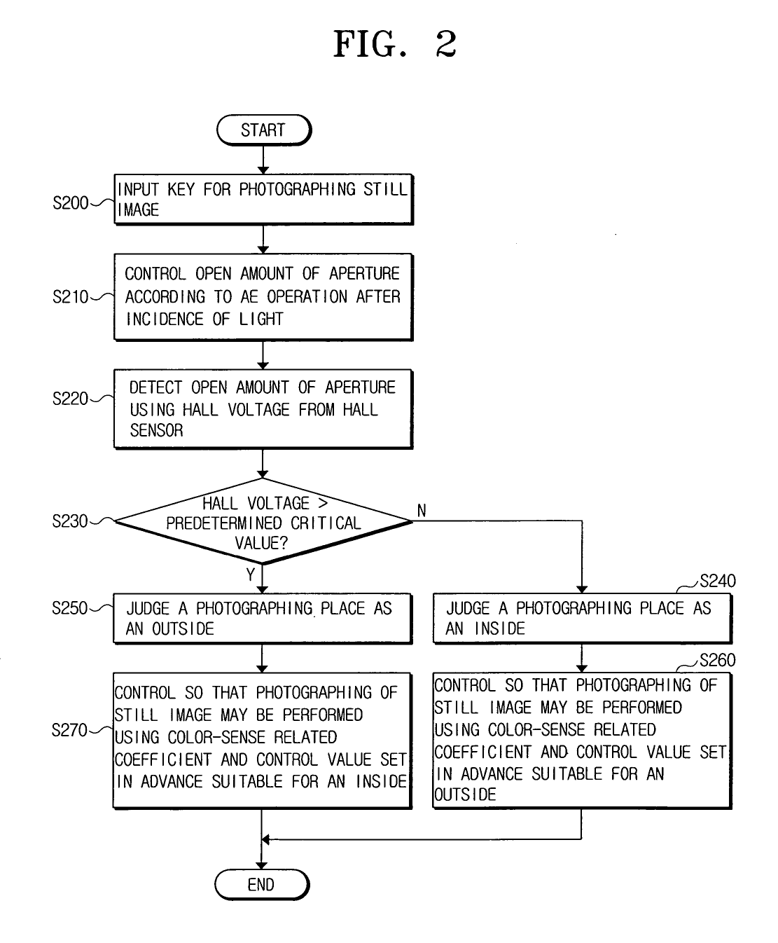

FIG. 2 is a flowchart explaining a still image photographing method for reproducing a color sense suitable for indoor and outdoor environments.

Referring to FIG. 2, first, a user commands a photograph of a still image by pressing a key for photographing a still image on the operation unit 80 (S200). If a photographing operation of a still image starts, the camera microcomputer 40 controls the motor operation unit 15 to operate the motor 14. Thus, an opened amount of the aperture 11 is set to a default condition.

If light is provided to the lens system 10, the opened amount of the aperture 11 is controlled by a general auto exposure operation (S210). That is, the aperture 11 is controlled so as to close under a bright conditions and to open under dark conditions.

At this point, the amount the aperture 11 is opened is detected by the Hall sensor 16 and is represented in form of a Hall voltage outputted from the Hall sensor 16 (S220).

The Hall voltage 16 is fed back to the camera microcomputer 40 and the camera microcomputer 40 to compare a size of the provided Hall voltage with a predetermined critical value (S230). Therefore, it is possible to recognize brightness of a environment where the photographing is taking place as a result of the comparison of the Hall voltage's size with the predetermined critical value. This information may be used to evaluate whether a place where the camcorder 100 is currently used is inside or outside.

Since incident light is strong under outside sunlight, the aperture 11 is closed and thus the Hall voltage is lowered. On the contrary, since incident light is weak under artificial light inside, the Hall voltage is increased.

If a Hall voltage's size provided from the Hall sensor 16 is smaller than a predetermined critical value stored in the EEPROM 60, the camera microcomputer 40 recognizes that the photographing is taking place outside (S240). If a Hall voltage's size provided from the Hall sensor 16 is larger than a predetermined critical value stored in the EEPROM 60, the camera microcomputer 40 recognizes the location of photographing as inside (S250).

In the meantime, a predetermined critical value stored in the EEPROM 60 is changeable by an operation of a user. Therefore, if a critical value is changed by an operation of a user, a reference on the basis of where photographing is taking place is also changed.

If a Hall voltage's size is smaller than a predetermined critical value and the camcorder 100 is being used outside, the camera microcomputer 40 controls photographing of a still image to be performed using color-sense related coefficient and control value set in advance suitable for an outside condition (S260).

That is, the camera microcomputer 40 reads color-sense related coefficient and control values set in advance suitable for an outside condition from the EEPROM 60. Then, the camera microcomputer 40 provides the coefficient and control values to a predetermined register assigned to the DSP 24. Here, the outside condition means a status such that the camcorder 100 maybe be properly used under sunlight.

The DSP 24 performs an image process on the basis of color-sense related coefficient and control values set in advance suitable for an outside condition. The values are provided from the camera microcomputer 40 to generate digital brightness and color signal. The digital signals are provided to the field memory 25.

On the contrary, if a Hall voltage's size is larger than a predetermined critical value and the camcorder 100 is being used inside, the camera microcomputer 40 controls in the apparatus in such a way that photographing of a still image can be performed using color-sense related coefficient and control values set in advance suitable for an inside condition (S270).

That is, the camera microcomputer 40 reads color-sense related coefficient and control values set in advance suitable for an inside condition from the EEPROM 60. The camera microcomputer 40 provides the coefficient and value to a predetermined register assigned to the DSP 24. Here, the inside condition means a status such that the camcorder 100 can be properly used under artificial light.

The DSP 24 performs an image process on the basis of color-sense related coefficient and control values suitable for an inside condition. The values are provided from the camera microcomputer 40 to provide digital brightness and color signals to the field memory 25.

The reason why inside and outside conditions are different and controls are varied is because of spectral characteristics of light. The spectral characteristics are varied depending on artificial light in indoor circumstances and sunlight in outdoor circumstances.

The system microcomputer 50 repeatedly reads data stored in the field memory 25 and displays the data on the output unit 90. Therefore, a user can check a still image using the output unit 90 mounted on the camcorder 100.

As described above, a still image photographing method for reproducing a color sense suitable for indoor and outdoor environment in accordance with an embodiment of the present invention has advantages of discriminating whether a place where the camcorder is currently used is inside or outside. Then, the apparatus photographs an object using a color sense suitable for the relevant circumstance. Therefore, it is possible to prevent an instance where a green color sense is excessively represented on an image when photographing a still image indoors or a green color sense is underrepresented on an image outdoors.

While the invention has been shown and described with reference to certain embodiments thereof, it will be understood by those skilled in the art that various changes in form and details may be made therein without departing from the spirit and scope of the invention as defined by the appended claims.

What is claimed is:

1. A still image photographing method for reproducing a color sense suitable for indoor and outdoor environments comprising the steps of:
commanding a image photographing apparatus to photograph a still image;
controlling an amount an aperture arranged on the apparatus is opened depending on incident light;
determining whether the photographing is being captured indoors or outdoors depending upon the amount the aperture is opened; and
controlling the apparatus so that photographing of the still image is based upon predetermined data set in advance that is suitable for the determined environment.

2. The method according to claim 1, wherein the step of determing whether the photographing is being captured indoors or outdoors comprises the steps of:
detecting the opened amount of the aperture using a predetermined sensor, and converting the detected opened amount into a predetermined voltage;
comparing the predetermined voltage with a predetermined critical value so that if the predetermined voltage is smaller than the predetermined critical value as a result of the comparison, it is determined that the photographing is being captured outdoors; and
if the predetermined voltage is larger than the predetermined critical value as a result of the comparison, it is determined that the photographing is being captured indoors.

3. The method according to claim 1, wherein the predetermined data is color-sense related data.

4. The method according to claim 2, wherein the predetermined sensor is a Hall sensor and the predetermined voltage is a Hall voltage which is outputted from the Hall sensor.

5. The method according to claim 2, wherein the predetermined critical value is changeable by a user.

6. A photographing apparatus comprising:
an operation block for commanding photographing of a still image;
an aperture configured to open and close a predetermined amount depending on incident light; and
a camera microcomputer for determining whether the still image is located in an indoor or outdoor environment depending upon the amount the aperture is opened, the camera microcomputer controls the photographing of the still image on the basis of predetermined data set in advance that is suitable for the determined environment.

7. The apparatus according to claim 6, further comprising:
a predetermined sensor for converting the detected opened amount of the aperture into a predetermined voltage,
wherein the camera microcomputer compares the predetermined voltage with a predetermined critical value and determines that the photographing is being captured outdoors if the predetermined voltage is smaller than the predetermined critical value and determines that the photographing is being captured indoors if the predetermined voltage is larger than the predetermined critical value.

8. The apparatus according to claim 7, wherein the predetermined sensor is a Hall sensor.

9. The apparatus according to claim 7, further comprising: an EEPROM (electronically eraseable programmable read-only memory) for storing a predetermined data set in advance suitable for indoor and outdoor environments, and a predetermined critical value.

10. The apparatus according to claim 9, wherein the predetermined data is color-sense related data.

11. The apparatus according to claim 9, wherein the predetermined critical value is changeable by a user.
